(19) United States
(12) Patent Application Publication
(10) Pub. No.: US 2011/0209834 A1
(43) Pub. Date: Sep. 1, 2011

(54) Window Covering Apparatus

(76) Inventors: John R. Lowry, Gilbert, AZ (US); Gordon L. King, Queen Creek, AZ (US); Don A. Patterson, Gilbert, AZ (US)

(21) Appl. No.: 13/038,322

(22) Filed: Mar. 1, 2011

Related U.S. Application Data
(60) Provisional application No. 61/309,268, filed on Mar. 1, 2010.

(51) Int. Cl. A47H 23/04; A47H 23/00; A47H 5/02; F16G 11/00; E06B 9/30

(52) U.S. Cl. 160/84.04; 160/340; 24/122.3; 160/168.1 R

(57) ABSTRACT

Exemplary window covering apparatus, assemblies, and associated methods are disclosed herein. An exemplary window covering apparatus comprises a headrail, a covering attached to and extending vertically downward from the headrail, a pull cord configured to be operated by a user, a lift cord connecting a bottom of the covering to the pull cord by way of the headrail, the lift cord configured to lift the bottom of the covering to collapse the covering toward the headrail or drop the bottom of the covering to extend the covering away from the headrail when the pull cord is operated by the user, and an elongate sheath that ensheathes an otherwise exposed segment of the lift cord.

### RELATED APPLICATIONS

The present application claims priority under 35 U.S.C. §119(e) to U.S. Provisional Patent Application No. 61/309,268 by John R. Lowry et al., filed on Mar. 1, 2010, and entitled “Window Covering Apparatus and Assembly, the contents of which are hereby incorporated by reference in their entirety.

### BACKGROUND

Window coverings such as blinds and shades are used to cover windows or other structural openings. Certain window coverings are configured to be operated by a user to control privacy and/or the amount of sunlight that enters a room. To this end, such window coverings may include one or more cords configured to support, lift, adjust, tilt, open, close, extend, release, and/or otherwise operate one or more other components of the window coverings. While advances have been implemented in window coverings to manage cords included in window coverings, a number of disadvantages still exist with respect to management of cords included in certain window coverings.

### BRIEF DESCRIPTION OF THE DRAWINGS

The accompanying drawings illustrate various embodiments of principles described herein and are a part of the specification. The illustrated embodiments are merely examples and do not limit the scope of the disclosure or the claims.

FIG. 1 is a perspective view of an exemplary window covering according to principles described herein.

FIGS. 2-4 are perspective views of an exemplary implementation of the window covering of FIG. 1 according to principles described herein.

FIGS. 5-7 are perspective views of another exemplary implementation of the window covering of FIG. 1 according to principles described herein.

FIG. 8 is a perspective view of another exemplary window covering according to principles described herein.

FIGS. 9-11 are perspective views of an exemplary implementation of the window covering of FIG. 8 according to principles described herein.

FIGS. 12-14 are perspective views of another exemplary implementation of the window covering of FIG. 8 according to principles described herein.

### DETAILED DESCRIPTION

Exemplary window covering apparatus, assemblies, and associated methods are disclosed herein. The exemplary window coverings disclosed herein may provide a number of benefits over conventional window coverings. For example, exemplary window coverings of the present disclosure may allow a manufacturer and/or user of the window coverings to better manage, control, and/or restrict the movement of cords associated with the operation of the window coverings. To illustrate, a window covering described herein may prevent or limit independent movement of one or more lift cords, which could otherwise be pulled by a user (e.g., away from the window covering) to form unsightly and/or possibly hazardous loops. As a result, the principles disclosed herein may provide for window coverings that better manage cords, are safer, and/or are more aesthetically pleasing than conventional window coverings.

In the following description, for purposes of explanation, numerous specific details are set forth in order to provide an understanding of exemplary window covering apparatus, assemblies, and associated methods. It will be apparent, however, that the exemplary apparatus, assemblies, and methods may be implemented, manufactured, and/or practiced without certain of these specific details. Reference in the specification to “an embodiment,” “an implementation,” “an example,” or similar language means that a particular feature, structure, or characteristic described in connection with the embodiment, implementation, or example is included in at least that one embodiment, implementation, or example but not necessarily in other embodiments, implementations, or examples. A particular feature, structure, or characteristic described in relation to one embodiment, implementation, or example may or may not be included in other embodiments, implementations, or examples. The various instances of the phrases “in an embodiment,”, “in an implementation,” “in one example,” or similar phrases used in the specification are not necessarily all referring to the same embodiment, implementation, or example.

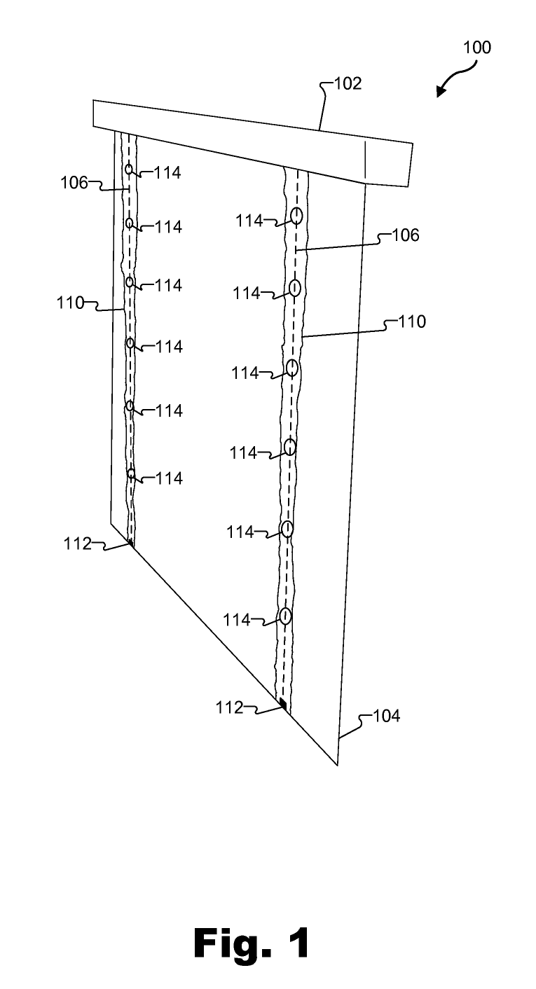

Turning now to the Figures, FIG. 1 is a perspective view of an exemplary window covering 100 according to principles described herein. Window covering 100, which may also be referred to as window covering apparatus 100 or window covering assembly 100, may be configured to be installed or positioned near a window in order to achieve one or more desired results (e.g., to manage privacy or sunlight coming through the window). To this end, window covering 100 may include a plurality of components configured to work independently and/or in combination to achieve the desired results. In particular, exemplary window covering 100 may include a headrail 102, a collapsible covering 104 (or “covering 104”) configured to selectively cover at least a portion of the window, one or more lift cords 106 (depicted as dashed lines in FIG. 1) configured to support, extend, and/or collapse covering 104, and one or more elongate lift cord sheaths 110 (or simply “sheaths 110”) through which segments of lift cords 106 may be disposed. In some examples, window covering 100 may include additional components (e.g., a bottom rail, a pull cord that may be operated by a user to operate the lift cords 106, etc.) or fewer components as may be desired for a particular application.

Headrail 102 may be configured to be fastened, through any suitable fastening mechanism (e.g., screws), to a structure proximate a window. Hence, headrail 102 may support and provide stability to window covering 100.

Headrail 102 may also house one or more mechanisms configured to operate window covering 100. For example, headrail 102 may house one or more mechanisms configured to assist in opening, closing, and/or adjusting covering 104. In one example, headrail 102 may include one or more mechanisms configured to assist in retracting lift cords 106 into headrail 102 in order to collapse covering 104 toward headrail 102 (to open covering) or in lowering lift cords 106 from headrail 102 to extend covering 104 from headrail 102 (to close covering).

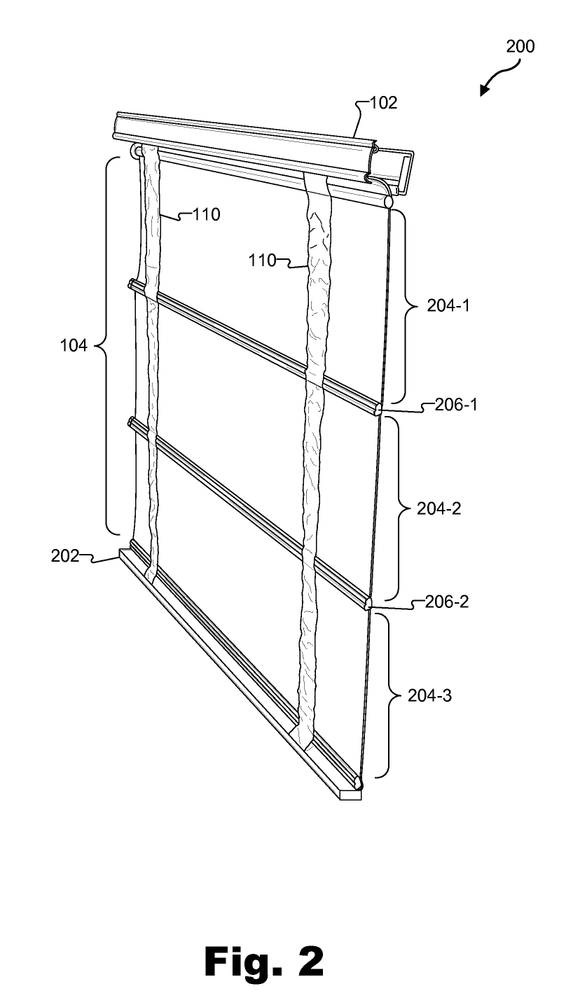

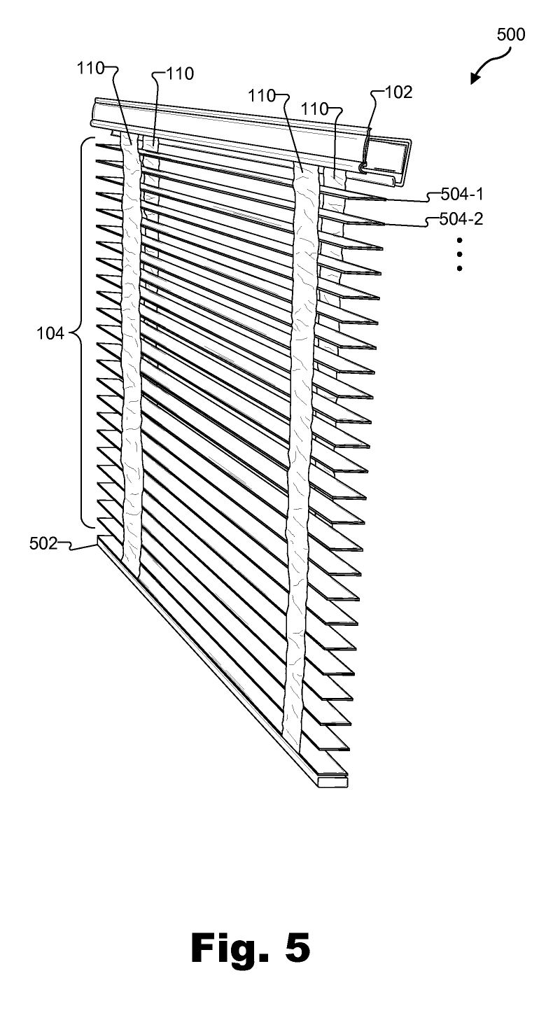

Covering 104 may be supported by headrail 102. For example, covering 104 may be attached to and extend vertically downward from headrail 102. Covering 104 may include any element or combination of elements configured to selectively cover at least a portion of a window. In certain exemplary implementations, covering 104 may have a roman/folding shade configuration including collapsible material (e.g., flexible fabric or plastic) supported by the headrail and configured to fold or collapse together from a closed configuration to an open configuration and/or to extend from an open configuration to a closed configuration, as described below in reference to FIGS. 2-4. In other exemplary implementations, covering 104 may have a horizontal blinds configuration including a plurality of horizontal slats (e.g., slats of wood, plastic, metal, natural material, synthetic material, etc.) configured to collapse together from a closed configuration to an open configuration and/or to extend from an open configuration to a closed configuration, as described below in reference to FIGS. 5-7. In other implementations, covering 104 may have any other suitable window covering configuration, such as those used in roller shades, drapes, and curtains, or any other suitable configuration.

Covering 104 may be adjusted, collapsed, extended (e.g., uncollapsed), and/or otherwise operated through the operation of one or more other components of window covering 100. For example, lift cords 106 may be configured to lift a bottom of covering 104 vertically upward to collapse covering 104 toward headrail 102 and/or to drop the bottom of covering 104 vertically downward to extend covering 104 away from headrail 102. To this end, headrail 102 may include one or more mechanisms (e.g., a pull cord or other mechanism) configured to allow a user to selectively and controllably retract lift cords 106 into headrail 102 or extend lift cords 106 from headrail 102.

Lift cords 106 may be fixedly coupled to covering 104. For example, each lift cord 106 may be fixedly coupled to an anchor point 112 at the bottom of covering 104, such as directly to covering 104 at a position proximate the bottom of covering 104 or to another component (e.g., bottom rail, clips, coupling, etc.) positioned proximate the bottom of covering 104.

In addition, lift cords 106 may be slidably coupled to covering 104 at one or more connection points 114 disposed at one or more vertical intervals between the bottom of covering 104 and headrail 102. The slidable couplings at connection points 114 may be achieved in any of a number of ways. In one example, lift cords 106 may pass through openings in covering 104 itself (e.g., through openings in the material of a roman shade or through a slat in a set of blinds). In another example, lift cords 106 may pass through one or more components (e.g., clips, rings, loops, horizontal beams, sheath 110, etc.) connected to covering 104 at connection points 114.

As lift cords 106 are retracted into headrail 102, lift cords 106 may slide through connection points 114 and lift covering 104 at anchor points 112. As a result, covering 104 may collapse or fold together from the bottom up, first collapsing between anchor points 112 and the bottom connection points 114, then between successive connection points 114 as the bottom of covering 104 and/or anchor points 112 approaches successive connection points 114. This process may continue until most of each lift cord 106 is retracted into the headrail 102 and covering 104 is collapsed and positioned proximate the headrail 102 in a fully collapsed configuration. Thereafter, lift cords 106 may be released to extend out of headrail 102 to allow covering 104 to lower and uncollapse as lift cords 106 extend out of headrail 102.

In certain implementations, while one end of each lift cord 106 is attached to an anchor point 112 at the bottom of covering 104, the opposite end of each lift cord 106 may be attached to or become a pull cord (not shown) that is configured to be operated by a user of window covering 100 to cause covering 104 to collapse toward headrail 102 (e.g., when the pull cord is pulled away from headrail 102) or to extend away from headrail 102 (e.g., when the pull cord is allowed to retract toward headrail 102). The opposite ends of lift cords 106 (i.e., the ends opposite anchor points 112) may become pull cords or be attached to a pull cord by a lift cord consolidator or by any other suitable mechanism.

In such implementations in which each lift cord 106 connects the bottom of covering 104 to a pull cord, the connection may be by way of headrail 102. For example, each lift cord 106 may run through headrail 102 to connect the bottom of covering 104 to the pull cord. To illustrate, each lift cord 106 may be disposed along a path that begins at an anchor point 112 at the bottom of covering 104, extends vertically upward along covering 104 from the anchor point 112 at the bottom of covering 104 to headrail 102, enters into headrail 102, traverses at least a portion of headrail 102 while within headrail 102, exits from headrail 102, and extends vertically downward from headrail 102 to become a pull cord or to attach to a lift cord consolidator attached to a pull cord. Accordingly, when a user pulls the pull cord away from headrail 102, lift cords 106 will lift the bottom of covering 104 to collapse covering 104 toward headrail 102. Conversely, when the user allows the pull cord to retract toward headrail 102, the bottom of covering 104 and the lift cords 106 attached thereto will drop downward to extend covering 104 away from headrail 102. Examples of a pull cord included in a window covering are described further below.

As mentioned above, window covering 100 may include one or more sheaths 110 through which lift cords 106 are slidably disposed. Sheaths 110 may ensheathe or otherwise enclose segments of lift cords 106 that would be otherwise exposed (e.g., exposed to a user of window covering 100). Sheaths 110 may ensheathe segments of lift cords 106 in any suitable way that allows lift cords 106 to slide longitudinally within sheaths 110.

FIG. 1 illustrates two separate sheaths 110 ensheathing segments of two separate lift cords 106. In the example shown in FIG. 1, each sheath 100, and the lift cord segment ensheathed by each sheath 110, is disposed along a vertical length of covering 104, extending from headrail 102 to the bottom of covering 104. FIG. 1 illustrates each sheath 110 in a fully extended position in which the length of each sheath 110 spans the vertical length of covering 104 when covering 104 is fully extended from headrail 102 (i.e., is in a closed position).

Sheath 110 may be connected or anchored to one or more other components of window covering 110. For example, sheath 110 may be anchored at one end to headrail 102 or proximate to headrail 102 (e.g., to the top of covering 104 that is disposed proximate to headrail 102) and at another end to an anchor point 112, or to a structure (e.g., bottom rail) proximate the bottom of covering 104. Sheath 110 may also be coupled to covering 104 at one or more connection points 114. The couplings at connection points 114 may be achieved by attaching the sheath 110 directly to covering 104 (e.g., using clips, fasteners, adhesives, threaded loops, etc.) or any element thereof (e.g., to the fabric of a roman shade, to the slats or ladder of horizontal blinds, etc.), or by use of an interference coupling created by passing lift cord 106 out of sheath 110, through connection point 114, and back into sheath 110 at each connection point 114. To this end, sheath 110 may include one or more openings proximate each connection point 114 to allow lift cord 106 to pass out of and back into sheath 110. In some examples, the openings in sheath 110 may be reinforced (e.g., by grommets). In other examples, sheath 110 may be coupled to covering 104 at connection points 114 in any other suitable way.

Sheaths 110 may be configured to protect, manage, and/or control lift cords 106. For example, each sheath 110 may be configured to limit an amount (i.e., length) of lift cord 106 that can be pulled out away from covering 104 between successive connection points 114. For example, each sheath 110 may be configured to prevent excess or “slack” in lift cord 106 from being pulled away from covering 104 between two connection points 114 to form a loop any larger than can be formed by sheath 110 itself. As a result, a manufacturer can utilize sheath 110 to control the size of loops that can be formed by slack in lift cord 106. Accordingly, the sheath 110 may remedy unsightliness or safety concerns associated with loops that may otherwise be formed from slack in lift cords 106.

Covering 104 may include any number of connection points 114 desired for a particular application. In some examples, connection points 114 may be strategically placed in order to limit the amount of lift cord 106 and/or sheath 110 disposed between successive connection points 114, and thereby limit the size of loops that can be formed by lift cord 106 and/or sheath 110 between successive connection points 114. In certain embodiments, for example, successive connection points 114 may be positioned no more than approximately seven or eight inches apart so as to set a limit on the length of the portion of lift cord 106 or sheath 110 disposed between successive connection points 114.

In some examples, a sheath 110 may be configured to resist or prevent longitudinal elongation of the sheath 110 and/or a segment of the sheath 110 beyond a predetermined length. In particular, the material or materials of which the sheath 110 is made may exhibit very little or substantially no elastic properties and may be configured to resist longitudinal elongation beyond the predetermined length. In certain examples, the predetermined length may correspond to an overall length of the sheath 110 or a segment of the sheath 110. In certain examples, the predetermined length may correspond to a dimension of covering 104. For example, the predetermined length may correspond to a vertical distance between successive connection points 114, between an anchor point 112 and an adjacent connection point 114, or between headrail 102 and an adjacent connection point 114. As another example, the predetermined length may correspond to a vertical length of covering 104 (i.e., from headrail 102 to the bottom of covering 104) when covering 104 is fully extended from headrail 102.

In addition to resisting or preventing elongation of sheath 110 or a segment of sheath 110 beyond a predetermined length, the material(s) of sheath 110 may be configured to crumple to allow sheath 110 and/or a segment of the sheath 110 to collapse to a length less than the predetermined length. For example, the material of sheath 110 may be configured to crumple up to collapse together with covering 104 (as covering 104 collapses toward headrail 102) and/or to extend from a crumpled up, collapsed position together with covering 104 (as covering 104 extends away from headrail 102). Hence, the collapsing and extending of sheath 110 or a segment of sheath 110 may coincide with the collapsing and extending of covering 104 or a segment of covering 104.

The material of sheath 110 may include any number of suitable synthetic or non-synthetic materials. In one example, the material of sheath 110 may include woven fabric, such as cotton, nylon, or polyester. The material of sheath 110 may also include one or more coatings disposed on one or more inner surfaces of sheath 110, such as a lubricious coating configured to facilitate relative movement (e.g., sliding) between the sheath 110 and the lift cord 106.

The size and shape of sheath 110 may vary as desired for a particular application. Sheath 110 may have any inner, cross-sectional opening large enough to encase a lift cord 106 and allow relative movement between sheath 110 and lift cord 106 (e.g., to allow the lift cord 106 to slide within the sheath 110). In some examples, sheath 110 may have a generally tubular configuration or may have a generally flat or ribbon-like configuration (e.g., two flat pieces of material being fastened together or a flat piece of material with ends folded and fastened together).

Each sheath 110 may have a one-piece configuration or a multi-piece configuration. For example, sheath 110 may have a one-piece configuration that extends substantially from headrail 102 to anchor point 112. In other examples, sheath 110 may have multiple separate segments, with each segment extending between successive connection points 114, between headrail 102 and an adjacent connection point 114, or between anchor point 112 and an adjacent connection point 114.

Sheaths 110 may also be configured to include one or more aesthetic elements. For example, sheaths 110 may be of any color and design desired to complement or match the appearance of other components of window covering 100, such as covering 104 and/or headrail 102.

As mentioned, in certain implementations, window covering 100 may have a roman shade configuration. FIGS. 2-4 illustrate an exemplary roman shade implementation 200 of window covering 100. As shown in FIGS. 2-4, implementation 200 may include headrail 102, covering 104 having a roman shade configuration, and sheaths 110 ensheathing segments of lift cords 106 (hidden within sheaths) extending from headrail 102 to a bottom rail 202 at the bottom of covering 104.

As shown, covering 104 having a roman shade configuration includes a plurality of panels 204 (e.g., a top panel 204-1, a middle panel 204-2, and a bottom panel 204-3 collectively referred to as “panels 204”) made of collapsible material (e.g., fabric) coupled together by horizontal beams 206 (e.g., top beam 206-1 and bottom beam 206-2 collectively referred to as “beams 206”). In additional or alternative examples, covering 104 may have any other collapsible shade configuration desired for a particular application.

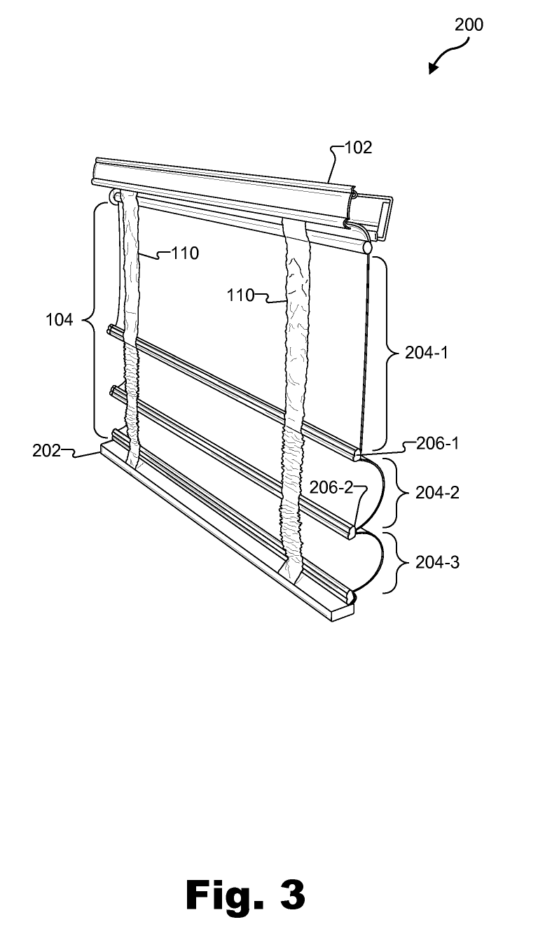

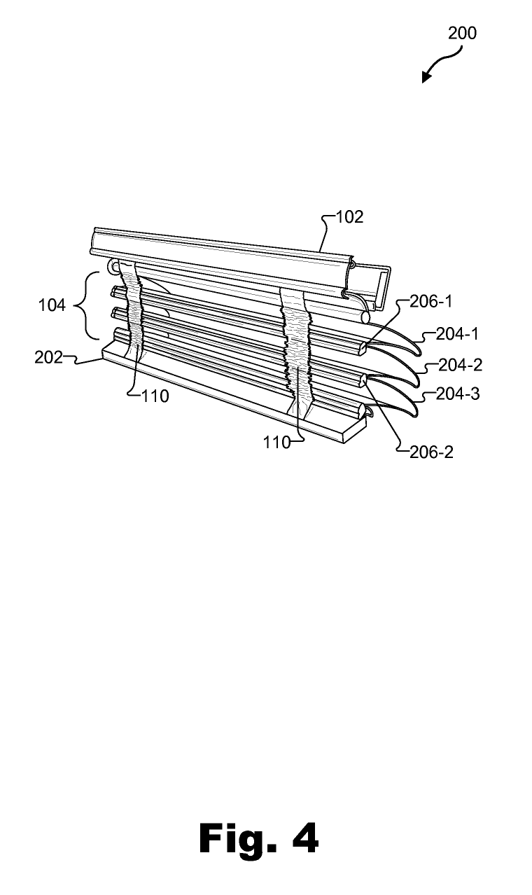

The operation of implementation 200, and any components thereof, may be like unto the operation of window covering 100, as described above. FIG. 2 illustrates implementation 200 with covering 104 fully extended away from headrail 102. In this position, sheaths 110 are also fully extended to span the vertical length of the fully extended covering 104. FIG. 3 illustrates implementation 200 with bottom rail 202 positioned closer to headrail 102 such that covering 104 is partially collapsed. In this position, sheaths 110 are also partially collapsed such that sheaths 110 span the vertical length of partially collapsed covering 104. FIG. 4 illustrates implementation 200 with bottom rail 202 positioned even closer to headrail 102 such that covering 104 is fully collapsed. In this position, sheaths 110 are collapsed such that sheaths 110 span the vertical length of fully collapsed covering 104. In this or a similar manner, the longitudinal collapsing of sheaths 110 may coincide with the collapsing of covering 104.

FIGS. 2-4 illustrate an order to the collapsing of covering 104 and sheaths 110. As lift cords 106 are retracted into headrail 102 causing bottom rail 202 to be raised toward headrail 102, covering 104 collapses, with the material of the bottom panel 204-3 collapsing first, followed by the material of the middle panel 204-2, and followed by the material of the top panel 204-1, until covering 104 is fully collapsed. As shown in FIGS. 2-4, coinciding with the collapse of the panels 204 of covering 104, portions of sheaths 110 that span the panels 204 may crumple up and collapse together with the panels 204. In reverse operation, as lift cords 106 extend out of headrail 102 and allow bottom rail 202 to drop away from headrail 102, the panels 204 of covering 104 and the corresponding sections of sheaths 110 uncollapse in reverse order such that covering 104 extends away from headrail 102.

As mentioned, in certain implementations window covering 100 may have a horizontal blinds configuration. FIGS. 5-7 illustrate an exemplary horizontal blinds implementation 500 of window covering 100. As shown in FIGS. 5-7, implementation 500 may include headrail 102, a bottom rail 502, covering 104 disposed between headrail 102 and bottom rail 502 and having a horizontal blinds configuration, and sheaths 110 ensheathing segments of lift cords 106 (hidden within sheaths) extending from headrail 102 to bottom rail 502.

As shown, covering 104 having a horizontal blinds configuration includes a plurality of horizontally oriented slats 504 (e.g., slats 504-1, 504-1, etc. collectively referred to as “slats 504”), which may be suspended by one or more collapsible and adjustable ladders (not shown). As is well known, each ladder may include two vertical cords extending vertically downward from headrail 102 to bottom rail 502 and a plurality of horizontal cords extending between and connecting the vertical cords 508. The horizontal cords may be configured to support the slats 504 and may be disposed intermittently along the length of the vertical cords so as to space apart the slats 504 when covering 104 is in a fully extended position.

The implementation 500 shown in FIGS. 5-7 comprises a routeless horizontal blinds configuration in which the lift cords 106 run external to and are coupled to slats 504. For example, the lift cords 106 disposed within sheaths 110 may run vertically downward from headrail 102 to bottom rail 502 along the backside and/or frontside of covering 104, without being routed through slats 504. FIGS. 5-7 show sheaths 110 running along both the frontside and backside of covering 104. Alternative implementations may include sheaths 110 running only along the frontside or the backside of covering 104.

Although implementation 500 is shown as having two pairs of sheaths 110, with each pair having one sheath 110 running along the frontside of covering 104 and another sheath 110 running along the backside of covering 104 (e.g., to function as vertical cords of a ladder), it will be appreciated that alternative implementations may have any number of sheaths 110 and/or pairs of sheaths 110 suitable for a particular application. For example, certain implementations such as implementation 500 may include a pair of two sheaths 110 for each ladder included in the implementations, and other implementations may include a single sheath 110 for each ladder included in the implementations, with the sheaths 110 all disposed on a front side of covering 104, all disposed on a back side of covering 104, or alternating between being disposed on the front side and the back side of covering 104.

The lift cords 106 and/or sheaths 110 may be coupled to the slats 504 in any suitable way, such as by being directly or indirectly coupled to vertical cords of ladders supporting the slats 504. The sheaths 110 and/or lift cords 106 may be coupled to the ladders at intermittent connection points 114 along the vertical lengths of the ladders. In some examples, the vertical cords of the ladders may pass through rings, clips, or loops (e.g., threaded loops) extending from the sheaths 110 and/or lift cords 106. As a result, the lift cords 106 may be slidable relative to the connection points 114 to allow operation of the lift cords 106 to open and close covering 104 of implementation 500. In other examples, the sheaths 110 themselves may replace and function as the vertical cords of the ladders. As a result, the sheaths 110 may enclose the lift cords 106, as described herein, and perform the functions of the vertical cords, thereby removing the need for both components separately.

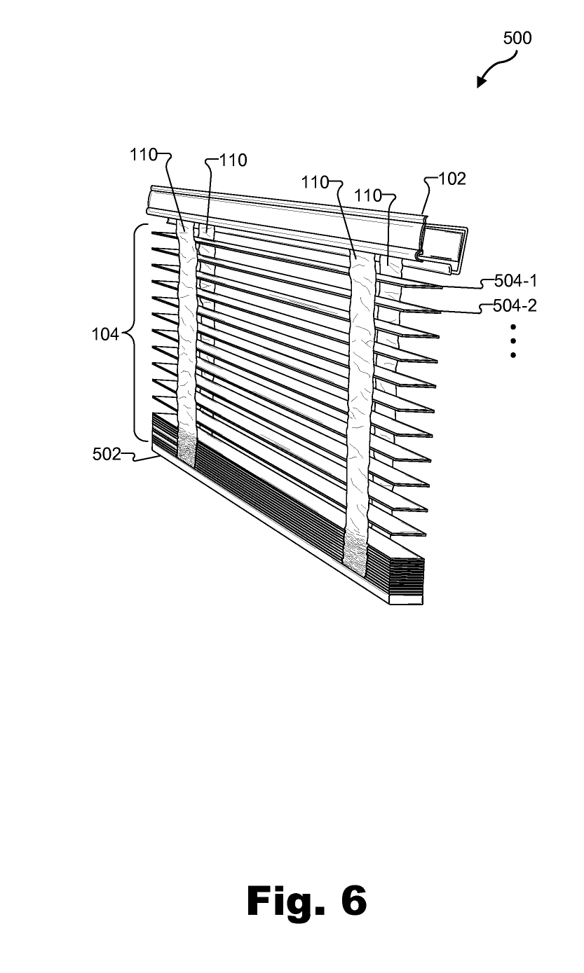

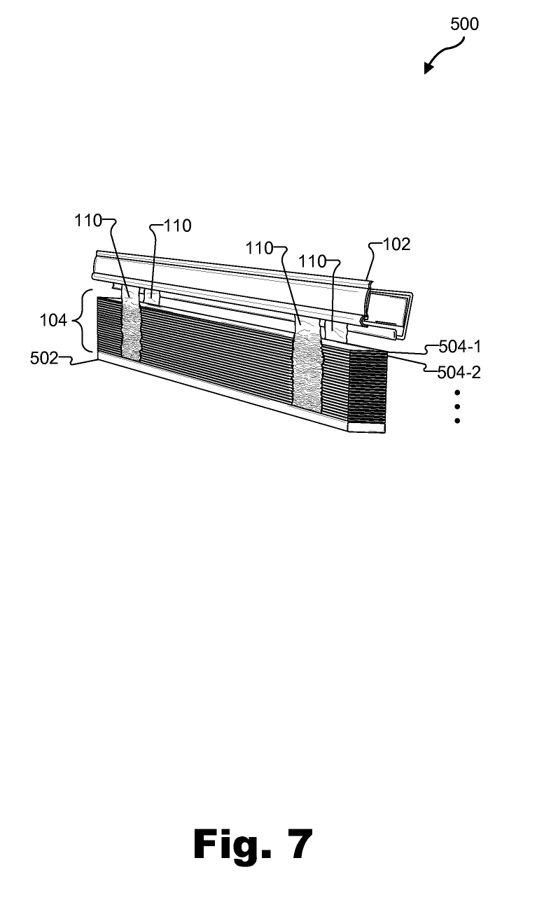

The operation of implementation 500, and any components thereof, may be like unto the operation of window covering 100, as described above. FIG. 5 illustrates implementation 500 with covering 104 fully extended away from headrail 102. In this position, sheaths 110 are also fully extended to span the vertical length of covering 104. FIG. 6 illustrates implementation 500 with bottom rail 502 positioned closer to headrail 102 such that covering 104 is partially collapsed. In this position, sheaths 110 are also partially collapsed such that sheaths 110 span the vertical length of partially collapsed covering 104. FIG. 7 illustrates implementation 500 with bottom rail 502 positioned even closer to headrail 102 such that covering 104 is fully collapsed. In this position, sheaths 110 are collapsed such that sheaths 110 span the vertical length of fully collapsed covering 104.

FIGS. 5-7 illustrate an order to the collapsing of covering 104 and sheaths 110. As lift cords 106 are retracted into headrail 102 causing bottom rail 502 to be raised toward headrail 102, covering 104 collapses, with the slats 504 disposed near the bottom rail 502 collapsing first and the collapsing of slats 504 progressing from the bottom up until the slats 504 are fully collapsed. As shown in FIGS. 5-7, coinciding with the collapse of the slats 504 of covering 104, portions of sheaths 110 that span the vertical distances between the slats 504 may crumple up and collapse together with the slats 504. In reverse operation, as lift cords 106 extend out of headrail 102 and allow bottom rail 502 to drop away from headrail 102, the slats 504 of covering 104 and the corresponding sections of sheaths 110 uncollapse in reverse order such that covering 104 extends away from headrail 102.

While implementation 500 comprises a routeless horizontal blind configuration (e.g., where the lift cords 106 run external to and are coupled to the horizontal slats 504), it will be appreciated that alternative implementations may have a routed horizontal blind configuration (e.g., where the lift cords 106 and/or sheaths 110 run through openings in the horizontal slats 504).

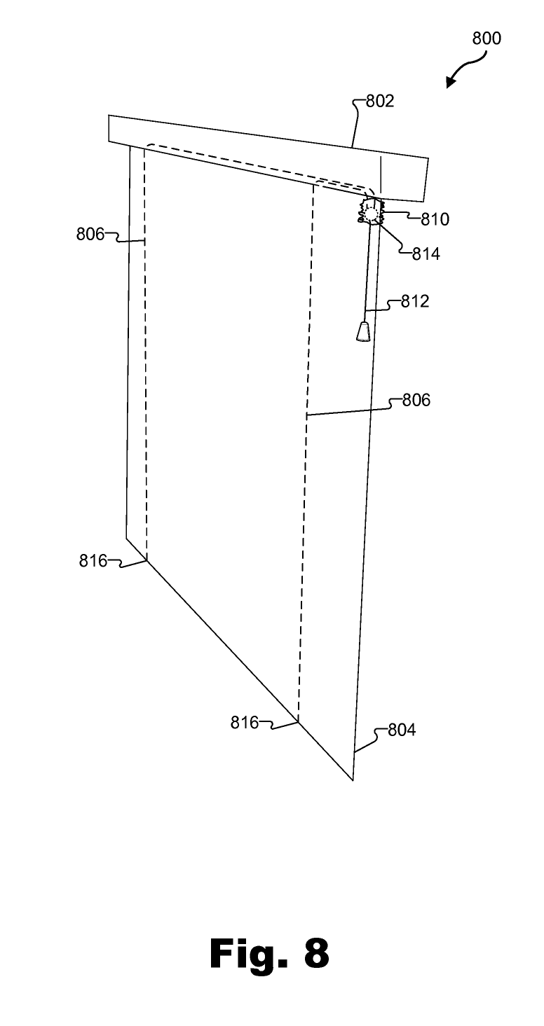

While FIGS. 1-7 are directed to an exemplary window covering 100 in which sheaths 110 ensheathe segments of lift cords 106 that extend substantially from the ends of the lift cords 106 attached at the bottom of covering 104 to headrail 102, additionally or alternatively, a window covering may include a sheath 110 that ensheathes additional or alternative segments of lifts cords 106 of the window covering. For example, FIG. 8 is a perspective view of another exemplary window covering 800 according to principles described herein. Window covering 800, which may also be referred to as window covering apparatus 800 or window covering assembly 800, may be like window covering 100 shown in FIG. 1, except that different segments of lift cords are ensheathed with a sheath. As shown in FIG. 8, window covering 800 may include a headrail 802, a collapsible covering 804 (or “covering 804”) configured to selectively cover at least a portion of the window, one or more lift cords 806 (depicted as dashed lines in FIG. 8) configured to support, extend, and/or collapse covering 804, and an elongate lift cord sheath 810 (or simply “sheath 810”) through which segments of lift cords 806 may be disposed. As further shown in FIG. 8, each lift cord 806 may connect the bottom of covering 804 to a pull cord 812 by way of headrail 802 and a lift cord consolidator 814 (depicted by a dashed-line perimeter of a circle in FIG. 8). More specifically, each lift cord 806 may be disposed along a path beginning at an anchor point 816 at the bottom of covering 804, extending vertically upward along covering 104 from the anchor point 816 to headrail 802, entering into headrail 802, traversing at least a horizontal segment of headrail 802, exiting headrail 802, and attaching to the lift cord consolidator 814 that is in turn attached to pull cord 812. In some examples, window covering 800 may include additional components (e.g., a bottom rail, one or more sheathes 110 ensheathing segments of lift cords 806 disposed between the bottom of covering 804 and headrail 802, etc.) or fewer components as may be desired for a particular application.

Headrail 802, covering 804, and lift cords 806 may function like headrail 102, covering 104, and lift cords 106, as described above. Sheath 810 may also function as sheath 110, except that sheath 810 is disposed to ensheathe different segments of lift cords 806, particularly segments of lift cords 806 that extend from headrail 802 to become pull cords or attach to a pull cord, such as pull cord 812, configured to be operated by a user to control covering 804. As shown in FIG. 8, sheath 810 may be disposed to extend substantially from headrail 804 to lift cord consolidator 814 such that sheath 810 ensheathes segments of lift cords 806 extending from headrail 802 to lift cord consolidator 814. In FIG. 8, sheath 810 also encloses lift cord consolidator 814. In some examples, the top end of sheath 810 may be attached to headrail 802 or to another component proximate headrail 802, and the bottom end of sheath 810 may be attached to lift cord consolidator 814 and/or pull cord 812.

Sheath 810 may be configured to protect, manage, and/or control lift cords 806. For example, sheath 810 may be configured to limit an amount (i.e., length) of lift cords 806 that can be pulled out away from one another and/or from covering 804. For example, sheath 810 may be configured to prevent excess or “slack” in lift cords 806 from being pulled to form a loop any larger than can be formed by sheath 810 itself. As a result, a manufacturer can utilize sheath 810 to control the size of loops that can be formed by slack in lift cords 806 extending from headrail 802 to become or attach to pull cord 812. Accordingly, sheath 810 may remedy unsightliness or safety concerns associated with loops that may otherwise be formed from slack in lift cords 806.

In some examples, sheath 810 may be configured to resist or prevent longitudinal elongation of the sheath 810 and/or a segment of the sheath 810 beyond a predetermined length. In particular, the material or materials of which the sheath 810 is made may exhibit very little or substantially no elastic properties and may be configured to resist longitudinal elongation beyond the predetermined length. In certain examples, the predetermined length may correspond to an overall length of the sheath 810 or a segment of the sheath 810. In certain examples, the predetermined length may correspond to a dimension of covering 804. For example, the predetermined length may correspond to a vertical distance between headrail 802 and lift cord consolidator 814 when covering 804 is in a fully collapsed position and pull cord 812 is in a fully extended position.

In addition to resisting or preventing elongation of sheath 810 or a segment of sheath 810 beyond a predetermined length, the material(s) of sheath 810 may be configured to crumple to allow sheath 810 and/or a segment of the sheath 810 to collapse to a length less than the predetermined length. For example, the material of sheath 810 may be configured to crumple up to collapse as pull cord 812 is retracted toward headrail 802 and/or to extend from a crumpled up, collapsed position as pull cord 812 is extended away from headrail 802. Hence, the collapsing and extending of sheath 810 or a segment of sheath 810 may coincide with the retracting and extending of pull cord 812.

The material of sheath 810 may include any number of suitable synthetic or non-synthetic materials. In one example, the material of sheath 810 may include woven fabric, such as cotton, nylon, or polyester. The material of sheath 810 may also include one or more coatings disposed on one or more inner surfaces of sheath 810, such as a lubricious coating configured to facilitate relative movement (e.g., sliding) between the sheath 810 and lift cords 806.

The size and shape of sheath 810 may vary as desired for a particular application. Sheath 810 may have any inner, cross-sectional opening large enough to encase one or more lift cords 806 and allow relative movement between sheath 810 and lift cords 806 (e.g., to allow the lift cords 806 to slide within the sheath 810). In some examples, sheath 810 may have a generally tubular configuration or may have a generally flat or ribbon-like configuration (e.g., two flat pieces of material being fastened together or a flat piece of material with ends folded and fastened together).

Sheath 810 may also be configured to include one or more aesthetic elements. For example, sheath 810 may be of any color and design desired to complement or match the appearance of other components of window covering 800, such as covering 804 and/or headrail 802.

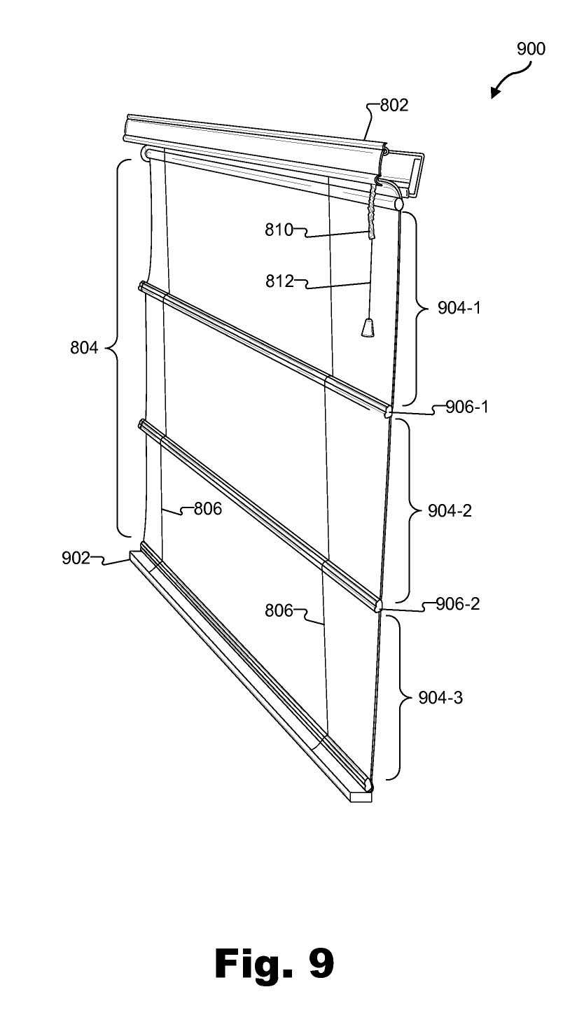

In FIG. 8, sheath 810 is illustrated in a fully collapsed position that coincides with covering 804 being in a fully extended position. Pull cord 812 may be pulled by a user such that pull cord 812 and lift cord consolidator 814 extend farther away from headrail 802, thereby causing lift cords 806 to lift anchor points 816 at the bottom of covering 804 upward toward headrail 802. This movement of the bottom of covering 804 toward headrail 802 causes covering 804 to collapse from the bottom up, until covering 804 is in a fully collapsed position. Coinciding with the collapse of covering 804, sheath 810 uncrumples and extends longitudinally such that sheath 810 may ensheathe an increased length of segments of lift cords 806. FIGS. 9-14 illustrate exemplary implementations of window covering 800 at various positions.

FIGS. 9-11 illustrate an exemplary roman shade implementation 900 of window covering 800. As shown in FIGS. 9-11, implementation 900 may include headrail 802, covering 804 having a roman shade configuration, and sheath 810 ensheathing segments of lift cords 806 (hidden within sheath) extending from headrail 802 to pull cord 812.

As shown, covering 804 having a roman shade configuration includes a plurality of panels 904 (e.g., a top panel 904-1, a middle panel 904-2, and a bottom panel 904-3 collectively referred to as “panels 904”) made of collapsible material (e.g., fabric) coupled together by horizontal beams 906 (e.g., top beam 906-1 and bottom beam 906-2 collectively referred to as “beams 906”). In additional or alternative examples, covering 804 may have any other collapsible shade configuration desired for a particular application.

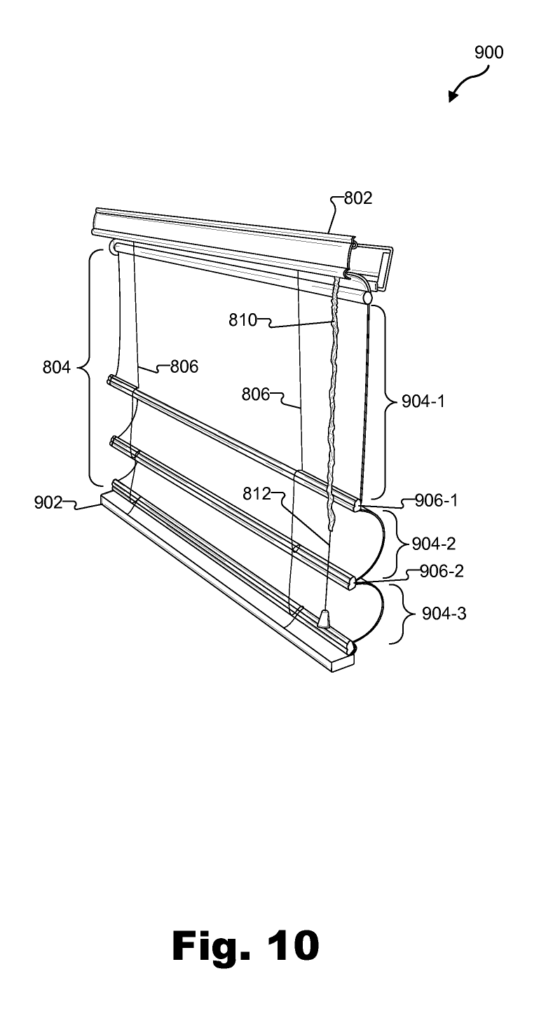

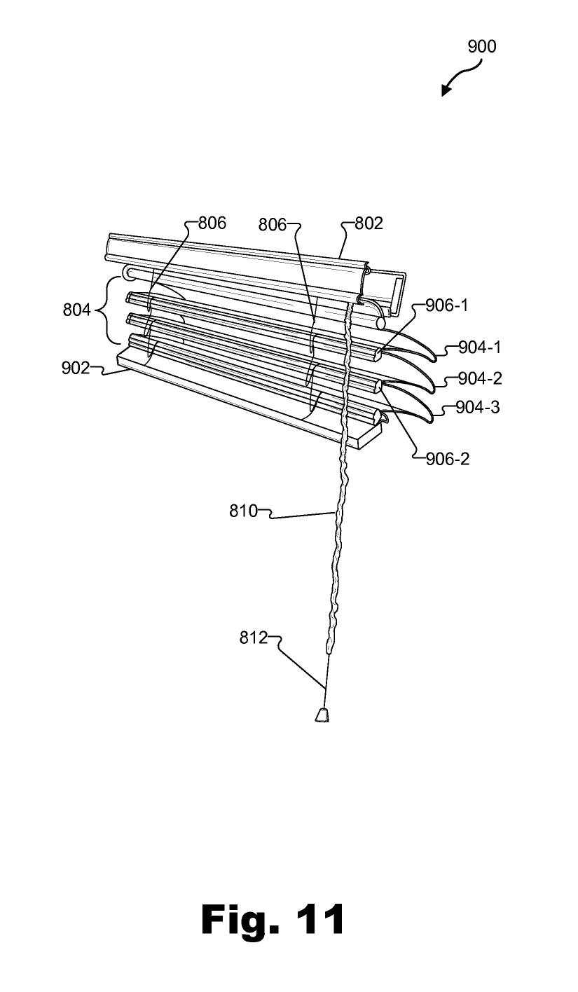

The operation of implementation 900, and any components thereof, may be like unto the operation of window covering 800, as described above. FIG. 9 illustrates implementation 900 with covering 804 fully extended away from headrail 802. In this position, sheath 810 is fully collapsed to span the vertical length of the segments of lift cords 806 extending from headrail 802 to pull cord 812. FIG. 10 illustrates implementation 900 with bottom rail 902 positioned closer to headrail 802 such that covering 804 is partially collapsed. In this position, sheath 810 is partially extended from the fully collapsed position such that sheath 810 spans the increased vertical length of the segments of lift cords 806 extending from headrail 802 to pull cord 812. FIG. 11 illustrates implementation 900 with bottom rail 902 positioned even closer to headrail 802 such that covering 804 is fully collapsed. In this position, sheath 810 is fully extended such that sheath 810 spans the further increased vertical length of the segments of lift cords 806 extending from headrail 802 to pull cord 812. In this or a similar manner, the extending of sheath 810 from a collapsed position may coincide with the collapsing of covering 804 from an extended position.

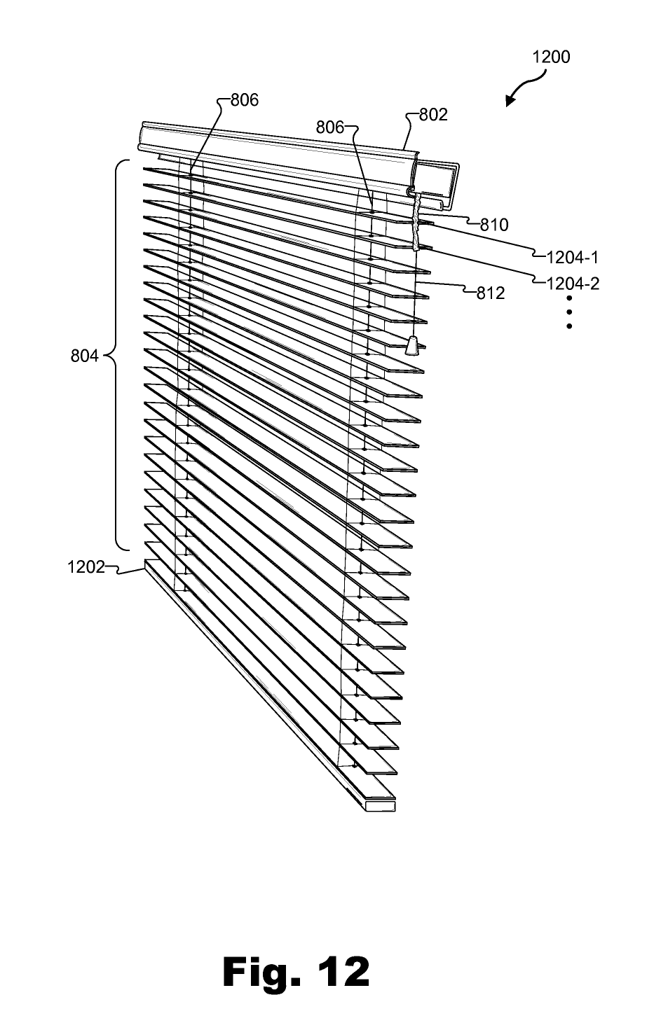

FIGS. 12-14 illustrate an exemplary horizontal blinds implementation 1200 of window covering 800. As shown in FIGS. 12-14, implementation 1200 may include headrail 802, a bottom rail 1202, covering 804 disposed between headrail 802 and bottom rail 1202 and having a horizontal blinds configuration, and sheath 810 ensheathing segments of lift cords 806 (hidden within sheath) extending from headrail 802 to pull cord 812.

As shown, covering 804 having a horizontal blinds configuration includes a plurality of horizontally oriented slats 1204 (e.g., slats 1204-1, 1204-1, etc. collectively referred to as “slats 1204”), which may be suspended by one or more collapsible and adjustable ladders. As is well known, each ladder may include two vertical cords extending vertically downward from headrail 802 to bottom rail 1202 and a plurality of horizontal cords extending between and connecting the vertical cords 508. The horizontal cords may be configured to support the slats 1204 and may be disposed intermittently along the length of the vertical cords so as to space apart the slats 1204 when covering 804 is in a fully extended position.

The implementation 1200 shown in FIGS. 12-14 comprises a routed horizontal blinds configuration in which the lift cords 806 are routed through openings in slats 1204. Alternative implementations may comprise routeless horizontal blinds configurations such as described herein.

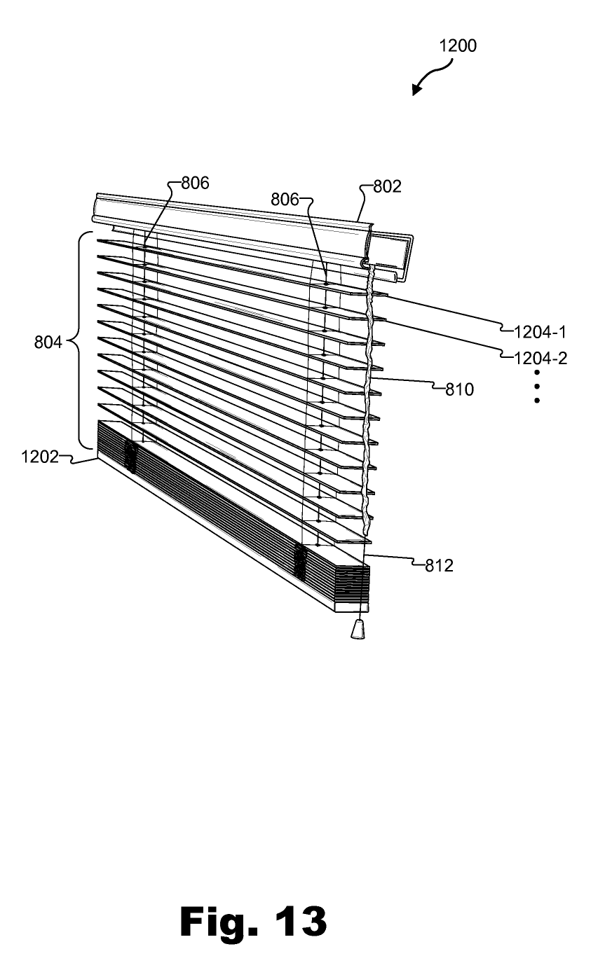

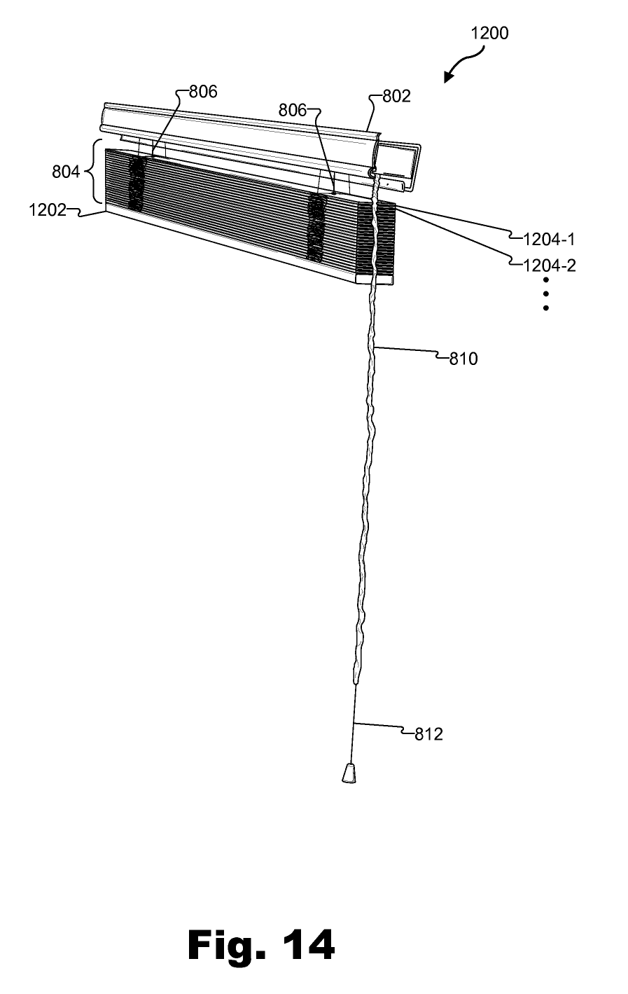

The operation of implementation 1200, and any components thereof, may be like unto the operation of window covering 800, as described above. FIG. 12 illustrates implementation 1200 with covering 804 fully extended away from headrail 802. In this position, sheath 810 is fully collapsed to span the vertical length of the segments of lift cords 806 extending from headrail 802 to pull cord 812. FIG. 13 illustrates implementation 1200 with bottom rail 1202 positioned closer to headrail 802 such that covering 804 is partially collapsed. In this position, sheath 810 is partially extended from the fully collapsed position such that sheath 810 spans the increased vertical length of the segments of lift cords 806 extending from headrail 802 to pull cord 812. FIG. 14 illustrates implementation 1200 with bottom rail 1202 positioned even closer to headrail 802 such that covering 804 is fully collapsed. In this position, sheath 810 is fully extended such that sheath 810 spans the further increased vertical length of the segments of lift cords 806 extending from headrail 802 to pull cord 812. In this or a similar manner, the extending of sheath 810 from a collapsed position may coincide with the collapsing of covering 804 from an extended position.

Although not illustrated in the drawings, the principles described above in reference to exemplary window coverings 100 and 800 may be combined in an exemplary window covering apparatus or assembly that includes a combination of the sheaths 110 of window covering 100 and the sheath 810 of window covering 800. The resulting window covering may include one or more separate sheaths disposed along a covering between the bottom of the covering and the headrail and a separate sheath disposed between the headrail and a pull cord.

The preceding description has been presented only to illustrate and describe exemplary embodiments with reference to the accompanying drawings. It will, however, be evident that various modifications and changes may be made thereto, and additional embodiments may be implemented, without departing from the scope of the invention as set forth in the claims that follow. The above description and accompanying drawings are accordingly to be regarded in an illustrative rather than a restrictive sense.

What is claimed is:

1. A window covering apparatus comprising:
a headrail;
a covering attached to and extending vertically downward from the headrail;
a pull cord configured to be operated by a user;
a lift cord connecting a bottom of the covering to the pull cord by way of the headrail, the lift cord configured to lift the bottom of the covering to collapse the covering toward the headrail or drop the bottom of the covering to extend the covering away from the headrail when the pull cord is operated by the user; and
an elongate sheath that ensheathes an otherwise exposed segment of the lift cord.

2. The apparatus of claim 1, wherein the sheath is configured to resist elongation beyond a predetermined length.

3. The apparatus of claim 2, wherein the predetermined length corresponds to a dimension of the covering.

4. The apparatus of claim 2, wherein the elongate sheath is configured to collapse to a length less than the predetermined length.

5. The apparatus of claim 4, wherein the elongate sheath comprises a fabric material configured to crumple when the elongate sheath is collapsed.

6. The apparatus of claim 1, wherein the elongate sheath is configured to allow the lift cord to slide longitudinally within the elongate sheath.

7. The apparatus of claim 1, wherein the segment of the lift cord ensheathed by the elongate sheath is disposed along a vertical length of the covering.

8. The apparatus of claim 1, wherein:
the lift cord is attached to the pull cord by a lift cord consolidator; and
the segment of the lift cord ensheathed by the elongate sheath is disposed between the headrail and the lift cord consolidator.

9. The apparatus of claim 8, further comprising:
an additional lift cord connecting the bottom of the covering to the pull cord by way of the headrail, the additional lift cord configured to lift the bottom of the covering to collapse the covering toward the headrail or drop the bottom of the covering to extend the covering away from the headrail when the pull cord is operated by the user;
wherein
the elongate sheath further ensheathes an otherwise exposed segment of the additional lift cord, and
the segment of the additional lift cord ensheathed by the elongate sheath is disposed between the headrail and the lift cord consolidator.

10. The apparatus of claim 1, wherein:
an end of the lift cord is fixedly coupled to the covering at the bottom of the covering; and
the lift cord is slidably coupled to the covering at one or more connection points along a vertical length of the covering.

11. The apparatus of claim 1, wherein the covering has a roman shade configuration including one or more panels of collapsible material.

12. The apparatus of claim 1, wherein the covering has a blinds configuration including a plurality of horizontal slats.

13. An apparatus comprising an elongate sheath ensheathing an otherwise exposed segment of a lift cord of a window covering assembly.

14. The apparatus of claim 13, wherein the segment of the lift cord ensheathed by the elongate sheath is disposed along a length of a covering of the window covering assembly, the covering configured to at least partially cover a window.

15. The apparatus of claim 13, wherein the segment of the lift cord ensheathed by the elongate sheath is disposed between a headrail of the window covering assembly and a lift cord consolidator attached to a pull cord configured to be operated by a user to cause a covering of the window covering assembly to collapse or extend.

16. The apparatus of claim 15, wherein:
the elongate sheath further ensheathes an otherwise exposed segment of an additional lift cord of the window covering assembly; and
the segment of the additional lift cord ensheathed by the elongate sheath is disposed between the headrail of the window covering assembly and the lift cord consolidator attached to the pull cord configured to be operated by the user to cause the covering of the window covering assembly to collapse or extend.

17. The apparatus of claim 13, wherein the elongate sheath is configured to resist elongation beyond a predetermined length.

18. The apparatus of claim 17, wherein the elongate sheath is configured to collapse to a length less than the predetermined length.

19. The apparatus of claim 18, wherein the elongate sheath comprises a fabric configured to crumple when the elongate sheath is collapsed.

20. A window covering apparatus comprising:
a headrail;
a covering attached to and extending vertically downward from the headrail;
a lift cord attached to and configured to lift a bottom of the covering to collapse the covering toward the headrail or drop the bottom of the covering to extend the covering away from the headrail; and
an elongate sheath that ensheathes a segment of the lift cord, the elongate sheath and the sheathed segment of the lift cord extending from the headrail to the bottom of the covering;
wherein the elongate sheath is configured to allow the lift cord to slide longitudinally within the elongate sheath and to collapse or extend together with the covering.
